(19) United States
(12) Patent Application Publication
(10) Pub. No.: US 2016/0283385 A1
(43) Pub. Date: Sep. 29, 2016

(54) FAIL-SAFE WRITE BACK CACHING MODE DEVICE DRIVER FOR NON VOLATILE STORAGE DEVICE

(71) Applicants: James A. Boyd, Hillsboro, OR (US); Sanjeev N. Trika, Portland, OR (US); Dale J. Juenemann, North Plains, OR (US)

(72) Inventors: James A. Boyd, Hillsboro, OR (US); Sanjeev N. Trika, Portland, OR (US); Dale J. Juenemann, North Plains, OR (US)

(21) Appl. No.: 14/671,871

(22) Filed: Mar. 27, 2015

(51) Int. Cl. G06F 12/08; G06F 12/02

(52) U.S. Cl. CPC G06F 12/0868; G06F 12/0806; G06F 12/0238; G06F 12/0877; G06F 2212/604; G06F 2212/621; G06F 2212/202; G06F 2212/6046; G06F 2212/603

(57) ABSTRACT

A method is described that includes performing the following by a device driver of a non volatile storage device: caching information targeted for the storage device into a non volatile region of a system memory without writing the information through into the storage device.

### FIELD OF INVENTION

Fail-Safe Write Back Caching Mode Device Driver For Non Volatile Storage Device

### BACKGROUND

Computing systems typically include system memory (or main memory) that contains data and program code of the software that the system's processor(s) are currently executing. Traditionally, non volatile storage (such as a disk drive) is used to store the program code when the system is powered off. Computer scientists are frequently trying to squeeze more performance out of non volatile storage (because it is usually slower than system memory) and reduce system memory power consumption.

### FIGURES

A better understanding of the present invention can be obtained from the following detailed description in conjunction with the following drawings, in which:

FIG. 1a shows a prior art storage device and device driver;

FIG. 1b shows a prior art storage device, device driver and driver filter;

FIG. 2 shows a computing system having a multi-level system memory;

FIG. 3 shows a first embodiment of a storage device, device driver and driver filter installed on a computing system having a multi-level system memory;

FIG. 4 shows a second embodiment of a storage device and device driver installed on a computing system having a multi-level system memory;

FIG. 5 shows a methodology that can be performed by either of the embodiments presented in FIGS. 4 and 5;

FIG. 6 shows a more detailed embodiment of a computing system.

### DETAILED DESCRIPTION

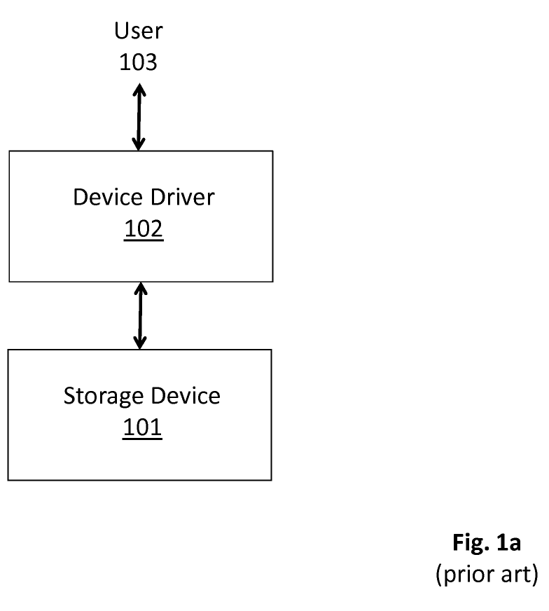

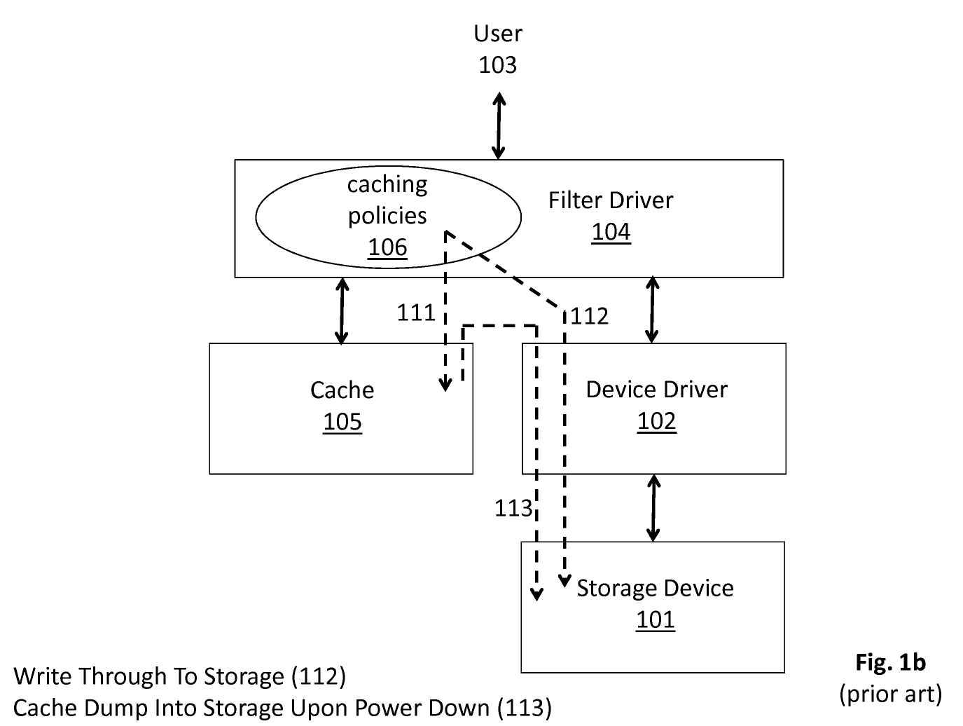

FIG. 1a shows a prior art storage device 101 and device driver 102. A device driver, as is understood in the art, is low level program code that is written for a particular item of hardware (in this case, storage device 101) so that the hardware item is useable to higher level software and/or person referred herein as a “user” 103. Here, the user 103 may be a virtual machine monitor, an operating system or operating system instance, or, an application software program (any of which may also include an actual person using or otherwise interfacing with the same). Typically, a device driver “plugs-into” or is integrated within an operating system or operating system instance for the use of the higher level user 103.

In a common application the storage device 101 is “block” based which means units of data are read from the storage device 101 and written into the storage device 101 in larger chunks (e.g., “blocks”, “sectors”, “pages”) than nominal accesses to system memory (or “main” memory) which typically write/read to/from in smaller sized data units (e.g., byte addressable cache lines).

A problem is that traditional block based storage devices (e.g., hard disk drives, solid state drives (SSDs)) tend to be slow. As such, referring to FIG. 1b, some prior art solutions have opted to include a “filter driver” 104 which is a separate instance of program code that can be installed to use an interface offered by the driver 102. The filter driver 104 incorporates caching intelligence into the overall solution to effectively boost the performance of the storage device 101 from the perspective of the user 103.

As observed in FIG. 1b, with the use of a filter driver 104, a caching layer 105 formed of an inherently faster memory or storage technology (e.g., a faster non volatile storage device or dynamic random access memory (DRAM) system memory). Here, blocks of information that are directed by higher level software toward the driver 102/104 for storage in the storage device 101 are instead cached in the faster caching layer. The filter driver 104 includes caching policy program code 106 which determines which blocks are to be stored in cache and which blocks are to be evicted from cache. Typically, the caching policies result in more recently and/or more frequently used items of data being kept in the caching layer 105 and, as a consequence, the user 103 should enjoy reduced accessed times obtaining these items. As discussed in more detail further below, the caching policy code 106 also typically implements a “write-through” rather than “write-back” caching policy.

The caching layer 105, as implemented by the filter driver 104, is typically a block based storage resource. That is, units of information are written to and read from the caching layer 105 in block units. Even in the case where the caching layer 105 is implemented as a section of DRAM system memory (in which case the filter driver 104 is referred to as a “DRAM filter driver”), the units of data that are written to and read from caching layer 105 are performed in units of blocks (e.g., by aggregating multiple system memory cache lines into a block). In cases where the cache 105 is implemented in system memory, the filter driver 104 is allocated a region of system memory which the filter driver 104 uses as the cache 105.

As can be seen in FIG. 1b, the filter driver 104 is responsible for managing the content of the caching layer 102 and for invoking the storage device 101 as appropriate with the caching scheme that is in place. The management and interfacing between the two different layers by the filter driver 104 can result in a number of complications which, in turn, may somewhat negate the performance boost to the storage device and overall system that the caching layer 105 is supposed to provide. These complications include “overhead” processes needed to maintain the data consistency between cached blocks and blocks that are stored in a low level storage device 101 of a system storage hierarchy.

With respect to data consistency issues, in the case of a DRAM filter driver, because of the non volatile nature of the DRAM caching layer 105, a “write-through” cache is typically implemented. In the case of a write-through cache, as observed in FIG. 1b, a duplicate copy of any data written into cache 111 is also automatically written 112 into the low level storage of a system storage hierarchy (e.g., as a follow-up process). Adding to the penalty of a write-through cache, a user is not typically informed that a write operation is “complete” until the copy has been written 112 into the low level storage 101 of a system storage hierarchy even if the data has already been written 111 into cache. That is, a user is not informed a write operation is complete after a write operation into cache 111. Rather, the user is only informed that the write operation is complete after the duplicate copy has been written 112 into the low level storage device 101 of a system storage hierarchy. Thus, with respect to writes anyway, a user may not even observe a performance improvement with the use of the cache (a performance improvement will be observed in cases of write-once-read-many, however).

Additionally, more traffic is introduced internally within the system (here, traffic is understood to be the various flows of information within the system). That is the write through process 112 not only introduces more traffic within the system but also causes filter driver 104 to include additional complex code in order to setup/arrange/control the write-through caching system. Further still, even if write-through caching is not adopted, again in the case a DRAM filter driver, because of the volatile nature of DRAM, the content of the caching layer 105 will need to be “dumped” 113 into the low level storage 101 of a system storage hierarchy upon a system power down cycle to preserve the content of the cached information. The problem of having more internal traffic as a consequence has been handled by reducing the effectiveness or “enjoyment” of the cache for write operations. That is, in some configurations, write operations are denied usage of the cache and the cache is only used for read operations.

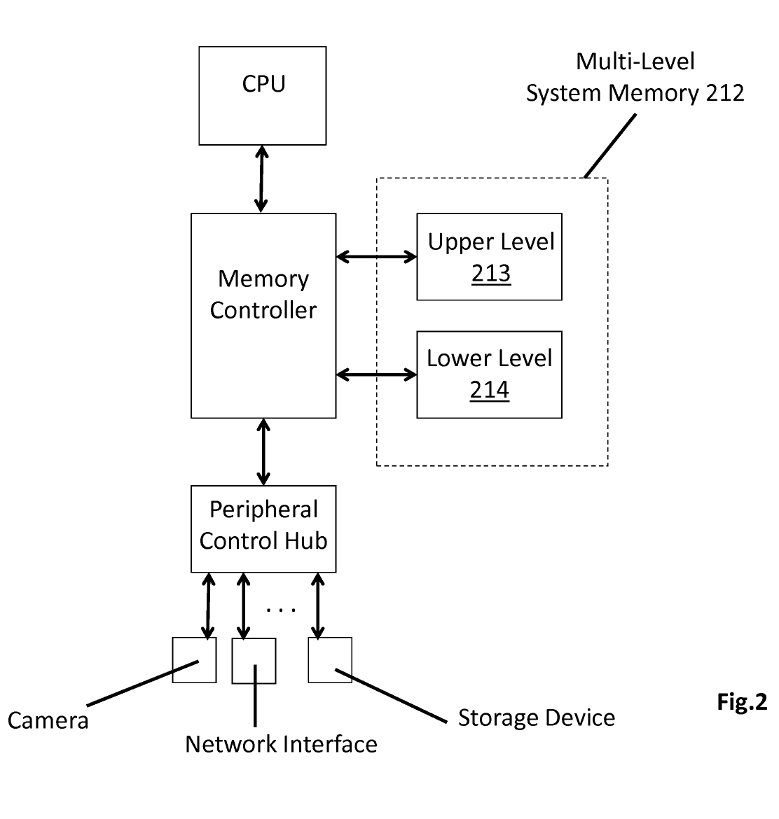

FIG. 2 shows an embodiment of a computing system 200 having a multi-tiered or multi-level system memory 212. Here, the multi-tiered system memory 212 includes an upper level 213 that has reduced access times as compared to the access times of the lower level 214. According to various embodiments, the lower level 214 is comprised of an emerging non volatile byte addressable random access memory technology such as, to name a few possibilities, a phase change based memory (e.g., PCM), a ferro-electric based memory (e.g., FRAM), a magnetic based memory (e.g., MRAM), a spin transfer torque based memory (e.g., STT-RAM), a resistor based memory (e.g., ReRAM) or a “Memristor” based memory.

Such emerging non volatile random access memories technologies typically have some combination of the following: 1) higher storage densities than DRAM (e.g., by being constructed in three dimensional (3D), e.g., crosspoint or otherwise, circuit structures); 2) lower power consumption densities than DRAM (e.g., for a same clock speed); and/or 3) access latency that is slower than DRAM yet still faster than traditional non-volatile memory technologies such as FLASH. The later characteristic in particular permits the emerging non volatile memory technology to be used in a main system memory role rather than a low level storage role of a system storage hierarchy (which is the traditional architectural location of non volatile storage (other than BIOS/firmware)).

Thus, even though the lower level 214 is comprised of a non volatile memory, in various embodiments at least a portion of the non volatile memory acts as a true system memory in that it supports finer grained data accesses (e.g., byte addressable cache lines) rather than larger blocked based accesses associated with traditional, low level non volatile storage of a system storage hierarchy, and/or, otherwise acts as an addressable memory that the program code being executed by processor(s) of the CPU operate out of.

The upper layer 213 may act as a cache for the lower layer 214 or as a level of system memory having a higher priority than the lower layer 214 (e.g., where more time sensitive (e.g., “real time”) data is kept). In the former case (upper layer 213 acts as a cache for the lower layer 214), the upper layer 213 may not have its own uniquely addressable system memory space (unique memory addresses are assigned to the lower level 214). In the later case (upper layer 213 acts as a higher priority system memory level), both the upper and lower layers 213, 214 may have their own separate uniquely addressable system memory space. In various embodiments the upper layer 213 is comprised of a DRAM based memory.

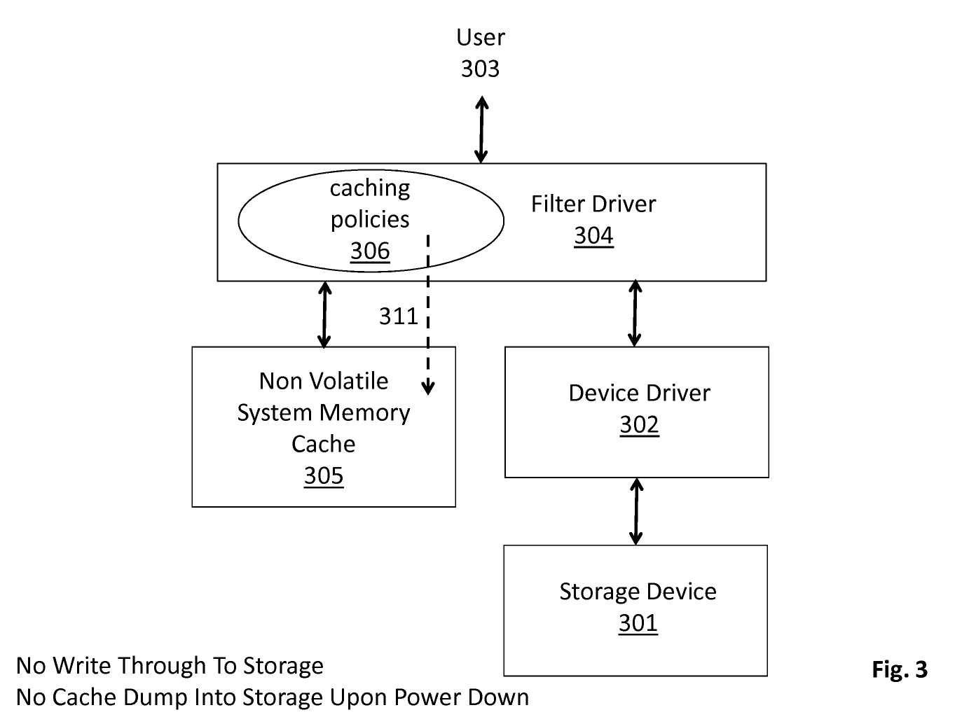

The presence of a non volatile level 214 of system memory opens up a wealth of possible system performance improvements and novel internal system workings and/or processes. FIG. 3 shows an improved approach in which, as with the approach of FIG. 1b, a filter driver 304 is installed that uses an interface offered by a storage device driver 302 to implement a non volatile caching layer 305 for a storage device 301 so that the perceived performance of the storage device 301 is improved. However, unlike the filter driver 104 of FIG. 1b, the filter driver 304 of FIG. 3 does not perform write-through caching because the caching layer 305 is implemented within a non volatile region of system memory such as region 214 of FIG. 2 discussed above.

Here, because the caching layer 305 is non-volatile, the need to synchronize a data block in cache 305 with any copy of itself (if any) in the low level storage device 301 of a system storage hierarchy in real time is greatly reduced. Should the system suffer a sudden power failure the data blocks in cache 305 will be preserved because of the non-volatile nature of the cache 305. As such, the motivation for a write-through caching scheme is largely diminished. This frees the filter driver 304 and the overall system of the costly internal write-through processes associated with the prior art approach of FIG. 1b.

Because of the lack of motivation to instill a write-through caching process, the filter driver 304 may configure itself (e.g., as a default) in a non write-through mode (e.g., a write-back mode as discussed further below). Here, a user may be specifically informed by the filter driver 304 that write-through caching will not be implemented unless the user specifically requests it. For example, the user may be informed by the filter driver 304 that a write-back cache will be implemented and/or that write through caching is not being implemented. As such, whereas prior art solutions may have only used the cache for read operations to avoid write through penalties for writes, with the new system, there is no penalty for writes and writes are free to use the cache as much as reads.

In the case of a write-back cache, no duplicate copy of a data block that is written 311 to cache 305 is written back to the storage device 301. Thus, in an embodiment, a filter driver 304 that implements a caching layer 305 within a layer of non volatile region of system memory may default or be hard-coded into a write-back mode rather than a write-through mode. To the extent the filter driver 304 may offer write-through mode, in an embodiment, a user has to affirmatively select it over and above a (e.g., default, preferred or suggested) write-back mode.

The implementation of the write-back mode may result in an immediate improvement in performance from the perspective of the user 303 relative to the prior art solution of FIG. 1b in two ways. First, the performance of the storage device 301 may be noticeably improved because the user 303 may be informed that a write is complete after it has been written in cache 305 rather than the after the additional latency has been consumed writing the block through to the storage device 301. Second, because the overall system has been freed of the write through transactions to the storage device 301, the system overall should be less congested resulting in faster performance of the system as a whole.

Additionally, also as observed in FIG. 3, the filter driver 304 does not need to implement a “dump” of all cached information from the cache 305 into the low level storage device 301 of a system storage hierarchy upon a sequenced power down process. That is, as part of the system's normal power down procedure, the information within the caching layer 305 remains there rather than being transferred to the storage device 301. As such, system power down procedures should be greatly simplified and/or consume less time (at least with respect to the storage device 301 itself if not the overall computing system).

Thus, as a basis of comparison, the prior art approach of FIG. 1b may have been able to offer a power-fail-safe mode but which operated with significant internally complicated processes. That is, in order to implement a power-fail-safe mode with the prior art approach of FIG. 1b, a write-through caching process had to be performed. Alternatively, if a write-through mode was not selected (e.g., a write-back mode was selected for higher performance), the system would not be able to operate in a power-safe-fail mode. Thus a user had to choose between performance and power-safe-fail.

By contrast, the improved approach of FIG. 3 permits a user to use a single configuration that includes both higher performance (through write-back caching rather than write-through caching) and a power-safe fail mode.

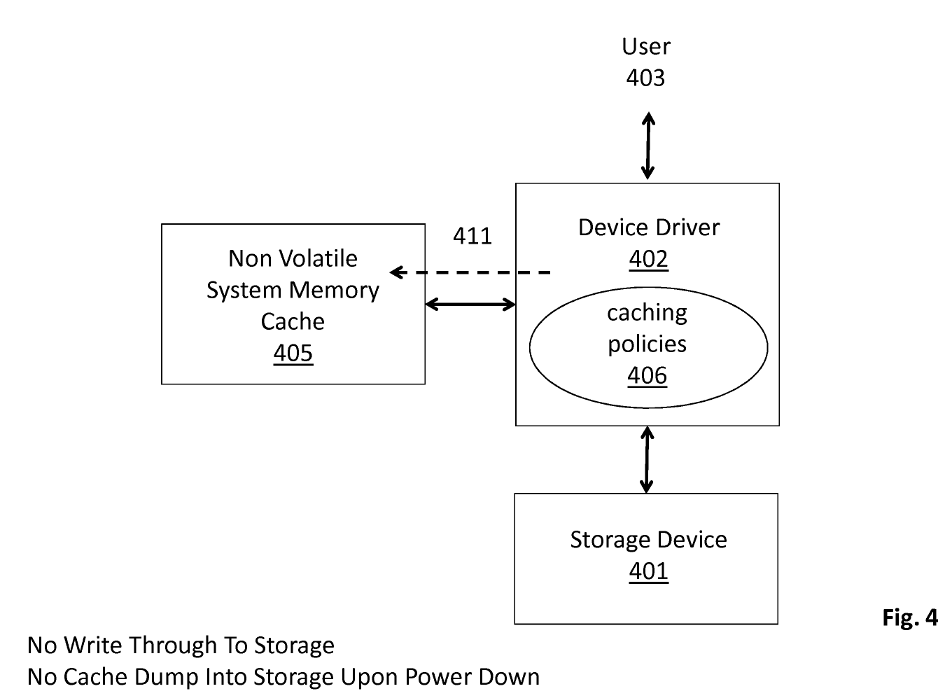

The approach of FIG. 3 demonstrated one embodiment where a filter driver 304 uses an interface offered by a storage device driver 302. By contrast, FIG. 4 shows that the functionality of the filter driver 304 of FIG. 3 can be integrated into the device driver 403 of the storage device. That is, whereas, the filter driver 304 and device driver 302 of FIG. 3 are physically separable items of program code (the filter driver 304 is installed on top of the device driver 302), by contrast, in the approach of FIG. 4, the cache filtering and storage driver functions are integrated into a single unit of un-separable code (storage device driver 402).

Here, the device driver 402 includes caching functionality code 406 (including, e.g., caching inclusion/eviction policy code). The caching functionality code 406 includes a mode of operation in which blocks of information that are written to cache 405 are not automatically written through to low level storage of a system storage hierarchy 401 nor are blocks of information in cache “dumped” into low level storage 401 of a system storage hierarchy upon a system power down cycle. As such, only a single item of program code (the device driver 402) needs to be installed into the system in order to effect system memory level caching for a storage device 401 that employs a write-back caching mode (and not write-through caching) and yet is still a power-safe-fail solution.

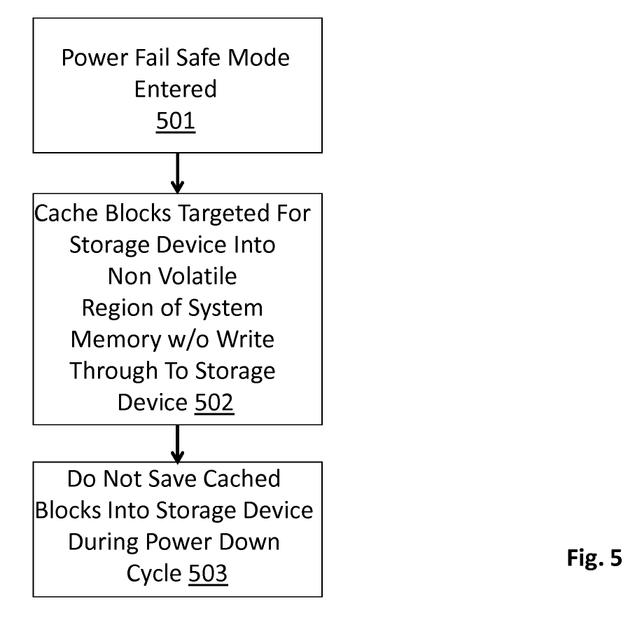

FIG. 5 shows a first embodiment of a methodology performed by either of the solutions of FIGS. 3 and 4. As observed in FIG. 5, a user of a storage device is informed that a power-safe-fail caching scheme for a storage device is in effect 501. Block items of data are then written to a cache implemented within a non volatile system memory region but no duplicate copy of the information is written through to the storage device 502. In response to a power down cycle, blocks within the cache are not saved into the storage device (rather, they remain in cache) 503. In the alternative, in the case of an unplanned power down, upon system initialization, the process will immediately look to non volatile memory cache for certain data items rather than the storage device.

In any of the embodiments described above with respect to FIGS. 3, 4, 5 (and particularly with respect to the non integrated approach of FIGS. 3 and 4), note that a same filter driver function may service/support more than one storage device. For example, the same filter driver may support both a hard disk drive and a solid state drive (e.g., by operating through the respective interfaces of their respective device drivers).

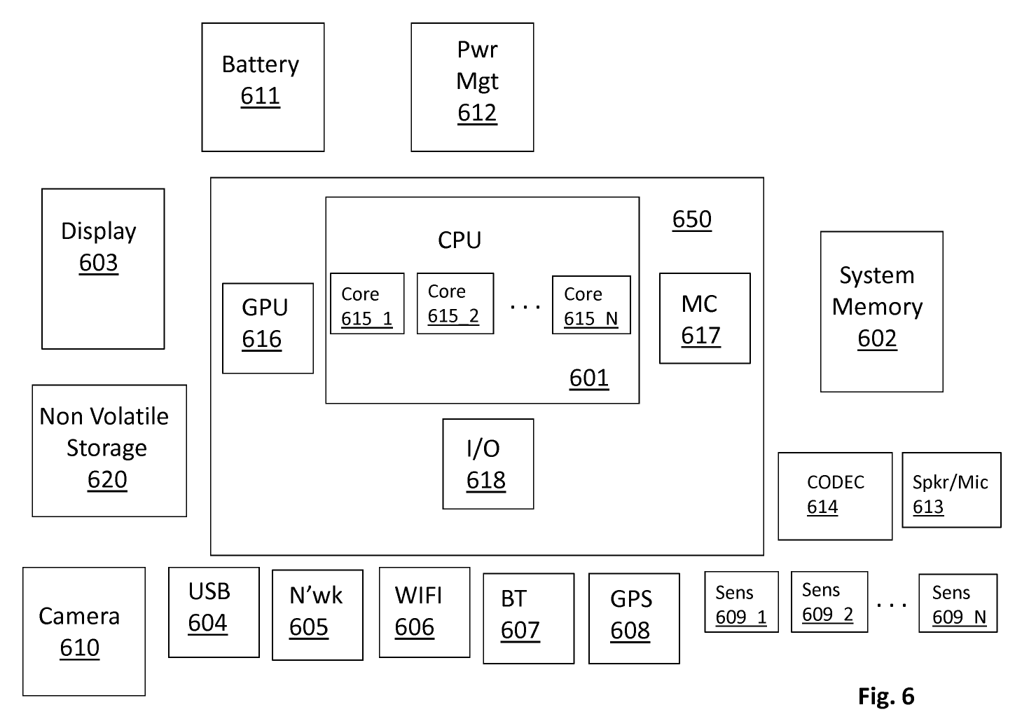

FIG. 6 shows a depiction of an exemplary computing system 600 such as a personal computing system (e.g., desktop or laptop) or a mobile or handheld computing system such as a tablet device or smartphone. As observed in FIG. 6, the basic computing system may include a central processing unit 601 (which may include, e.g., a plurality of general purpose processing cores and a main memory controller disposed on an applications processor or multi-core processor), system memory 602, a display 603 (e.g., touchscreen, flat-panel), a local wired point-to-point link (e.g., USB) interface 04, various network I/O functions 605 (such as an Ethernet interface and/or cellular modem subsystem), a wireless local area network (e.g., WiFi) interface 606, a wireless point-to-point link (e.g., Bluetooth) interface 607 and a Global Positioning System interface 608, various sensors 609_1 through 609_N (e.g., one or more of a gyroscope, an accelerometer, a magnetometer, a temperature sensor, a pressure sensor, a humidity sensor, etc.), a camera 610, a battery 611, a power management control unit 612, a speaker and microphone 613 and an audio coder/decoder 614.

An applications processor or multi-core processor 650 may include one or more general purpose processing cores 615 within its CPU 601, one or more graphical processing units 616, a memory management function 617 (e.g., a memory controller) and an I/O control function 618. The general purpose processing cores 615 typically execute the operating system and application software of the computing system. The graphics processing units 616 typically execute graphics intensive functions to, e.g., generate graphics information that is presented on the display 603. The memory control function 617 interfaces with the system memory 602. The system memory 602 may be a multi-level system memory such as the multi-level system memory 212 observed in FIG. 2 having a non volatile memory region. During operation, data and/or instructions are typically transferred between low level non volatile (e.g., “disk”) storage 620 of a system storage hierarchy and system memory 602. The power management control unit 612 generally controls the power consumption of the system 600.

Each of the touchscreen display 603, the communication interfaces 604-607, the GPS interface 608, the sensors 609, the camera 610, and the speaker/microphone codec 613, 614 all can be viewed as various forms of I/O (input and/or output) relative to the overall computing system including, where appropriate, an integrated peripheral device as well (e.g., the camera 610). Depending on implementation, various ones of these I/O components may be integrated on the applications processor/multi-core processor 650 or may be located off the die or outside the package of the applications processor/multi-core processor 650.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
performing the following by a device driver of a non volatile storage device:
caching information targeted for said storage device into a non volatile region of a system memory without writing said information through into said storage device.

2. The method of claim 1 further comprising leaving said information within said non volatile region of system memory and not transferring said information from said non volatile region of system memory to said storage device as part of a power down cycle of a computing system having said device driver and said storage device.

3. The method of claim 1 wherein said device driver is a filter driver.

4. The method of claim 1 wherein said device driver accesses said storage device without communicating with a lower separable device driver.

5. The method of claim 1 wherein said system memory is a multi-level system memory.

6. The method of claim 1 wherein said non volatile region of system memory is composed of any of:
a phase change memory;
a ferro-electric memory;
a magnetic memory;
a spin transfer torque memory;
a resistor memory;
a Memristor memory.

7. The method of claim 1 wherein said method further comprises informing a user that said storage device is operating in a power-fail-safe mode.

8. The method of claim 1 further comprising permitting a user to over-ride a default write-back caching mode in favor of a write-through mode.

9. A computer readable storage medium having stored thereon device driver program code for a non volatile storage device that when processed by one or more processors of a computing system causes a method to be performed, the method comprising:
caching information targeted for said storage device into a non volatile region of a system memory without writing the information through into said storage device.

10. The computer readable storage medium of claim 9 further comprising leaving said information within said non volatile region of system memory and not transferring said information from said non volatile region of system memory to said storage device as part of a power down cycle of a computing system having said device driver and said storage device.

11. The computer readable storage medium of claim 9 wherein said device driver is a filter driver.

12. The computer readable storage medium of claim 9 wherein said device driver accesses said storage device without communicating with a lower, separable device driver.

13. The computer readable storage medium of claim 9 wherein said system memory is a multi-level system memory.

14. The computer readable storage medium of claim 9 wherein said non volatile region of system memory is composed of any of:
a phase change memory;
a ferro-electric memory;
a magnetic memory;
a spin transfer torque memory;
a resistor memory;
an Memristor memory.

15. The computer readable storage medium of claim 9 wherein said method further comprises informing a user that said storage device is operating in a power-fail-safe mode.

16. The computer readable storage medium of claim 9 further comprising permitting a user to over-ride a default write-back caching mode in favor of a write-through mode.

17. A computing system, comprising:
a) one or more processors coupled to a memory controller;
b) a multi-level system memory coupled to said memory controller, said multi-level system memory comprising a non volatile system memory region;
c) a computer readable storage medium having stored thereon device driver program code for a non volatile storage device of said computing system that when processed by the one or more processors of said computing system causes a method to be performed, the method comprising:
caching information targeted for said storage device into said non volatile region of a system memory without writing the information through into the storage device.

18. The computer system of claim 17 further comprising leaving said information within said non volatile region of system memory and not transferring said information from said non volatile region of system memory to said storage device as part of a power down cycle of a computing system having said device driver and said storage device.

19. The computer system of claim 18 wherein said device driver is a filter driver.

20. The computer system of claim 17 wherein said device driver accesses said storage device without communicating with a lower, separable device driver.

21. The computer system of claim 17 wherein said system memory is a multi-level system memory.

22. The computer system of claim 17 wherein said non volatile region of system memory is composed of any of:
a phase change memory;
a ferro-electric memory;
a magnetic memory;
a spin transfer torque memory;
a resistor memory;
an Memristor memory.

23. The computer system of claim 17 wherein said method further comprises informing a user that said storage device is operating in a power-fail-safe mode.

24. The computer system of claim 17 further comprising permitting a user to over-ride a default write-back caching mode in favor of a write-through mode.
